(19) United States
(12) Patent Application Publication
(10) Pub. No.: US 2024/0012243 A1
(43) Pub. Date: Jan. 11, 2024

(54) Virtual Reality Hardware

(71) Applicant: Meta Platforms Technologies, LLC, Menlo Park, CA (US)

(72) Inventors: Charlene Mary ATLAS, Redmond, WA (US); Nadine Sharon ANGLIN, Los Angeles, CA (US); Dong YANG, Milpitas, CA (US); Jianjun JU, Suzhou (CN); Chih-Chen SUN, Xinyi District (TW); Jian ZHANG, San Jose, CA (US); Wanli WU, Shanghai (CN)

(73) Assignee: Meta Platforms Technologies, LLC, Menlo Park, CA (US)

(21) Appl. No.: 18/455,062

(22) Filed: Aug. 24, 2023

Related U.S. Application Data
(60) Provisional application No. 63/477,901, filed on Dec. 30, 2022.
(60) Provisional application No. 63/375,326, filed on Sep. 12, 2022.
(60) Provisional application No. 63/374,276, filed on Sep. 1, 2022.

(51) Int. Cl. G02B 27/01; G06T 19/00

(52) U.S. Cl. CPC G02B 27/017; G06T 19/006; G02B 2027/0178

(57) ABSTRACT

In some implementations, the disclosed systems and methods can include one or more tinting elements (e.g., flip-down blacked-out lenses, a blacked-out slider, or a blacked-out removeable cover) configured to cover the lenses of the MR glasses. In some implementations, the disclosed systems and methods can be coupled to one or more micro electrical motors configured to drive the clear fluid into and out of the pairs of clear flexible membranes, in order to make the focus tunable lenses concave to correct myopia, or convex to correct hyperopia or presbyopia. In some implementations, the disclosed systems and methods can be directed to online calibration of headset proximity sensors to mitigate after factory sensor drift and prevent automatic OFF and ON system failures.

### CROSS REFERENCE TO RELATED APPLICATIONS

This application claims priority to U.S. Provisional Application No. 63/374,276 filed Sep. 1, 2022 and titled “Virtual Reality Adapter for Mixed Reality Glasses,” 63/375,326 filed Sep. 12, 2022 and titled “Focus Tunable Lenses for an Artificial Reality Headset,” and 63/477,901 filed Dec. 30, 2022 and titled “Headset Proximity Sensor Calibration.” Each patent application listed above is incorporated herein by reference in their entireties.

### BACKGROUND

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR experiences can be observed by a user through a head-mounted display (HMD), such as glasses or a headset. An MR HMD can have a pass-through display, which allows light from the real-world to pass through a waveguide that simultaneously emits light from a projector in the MR HMD, allowing the MR HMD to present virtual objects intermixed with real objects the user can actually see.

An XR environment utilizing head-mounted displays (e.g., smart glasses, VR/AR headsets), projection “cave” systems, or other computing systems can present an XR environment to a user, who can interact with virtual objects in the environment. The utility of the XR system depends on the ability to convey the virtual environment to the user. Accordingly, calibration of XR systems including sensor components is important to ensure functioning of the XR system.

Generally, sensor calibration is an adjustment performed on a sensor to ensure accurate functioning. The sensor values can be correlated with those of a standard value to check the accuracy of the sensor. The sensor can be adjusted based on this correlation. Initially, sensor calibration of XR systems can be performed at the factory. However, sensor drift can occur after factory calibration, e.g., due to temperature changes and motion occurring during handling, transportation, and shipping.

### SUMMARY

Aspects of the present disclosure are directed to a virtual reality (VR) adapter for mixed reality (MR) glasses. In some implementations, the VR adapter can include one or more tinting elements (e.g., flip-down blacked-out lenses, a blacked-out slider, or a blacked-out removeable cover) configured to cover the lenses of the MR glasses. The VR adapter can further include one or more clip-on elements that can block light from the periphery of the MR glasses. In some implementations, the clip-on elements can include additional display screens for a more immersive VR experience and/or additional computing elements such as memory, battery, processors, storage, interfaces, etc.

Further aspects of the present disclosure are directed to correcting myopia, hyperopia, and/or presbyopia using focus tunable lenses in an artificial reality (XR) headset. The focus tunable lenses can include pairs of clear flexible membranes positioned inside the XR headset that are filled with clear fluid therebetween. The focus tunable lenses can be coupled to one or more micro electrical motors configured to drive the clear fluid into and out of the pairs of clear flexible membranes, in order to make the focus tunable lenses concave to correct myopia, or convex to correct hyperopia or presbyopia.

Additional aspects of the present disclosure are directed to online calibration of headset proximity sensors to mitigate after factory sensor drift and prevent automatic OFF and ON system failures. In one embodiment, a baseline setting for a proximity sensor of a headset is recalibrated upon determining the headset and the controllers are on a charging dock and motion readings from the headset indicate the headset is stationary for a predetermined period of time.

### BRIEF DESCRIPTION OF THE DRAWINGS

FIG. 1A is a conceptual diagram of an apparatus including mixed reality glasses and a virtual reality adapter including a flip-down cover.

FIG. 1B is a conceptual diagram of an apparatus including mixed reality glasses and a virtual reality adapter including a clip-on cover.

FIG. 1C is a conceptual diagram of an apparatus including mixed reality glasses and a virtual reality adapter including a clip-on cover and attachments configured to block a peripheral view of a real-world environment from a user wearing the mixed reality glasses.

FIG. 2 is a flow diagram illustrating a process used in some implementations for adapting mixed reality glasses for a virtual reality experience.

FIG. 3A is a conceptual diagram of an example existing artificial reality headset having spacers to accommodate eyeglasses of a user.

FIG. 3B is a conceptual diagram of an example existing artificial reality headset having detachable lenses.

FIG. 4 is a conceptual diagram of an example artificial reality headset having focus tunable lenses according to some implementations of the present technology.

FIG. 5A is a conceptual diagram of an example focus tunable lens in an artificial reality headset for a user with normal vision acuity according to some implementations of the present technology.

FIG. 5B is a conceptual diagram of an example focus tunable lens in an artificial reality headset for a user with myopia according to some implementations of the present technology.

FIG. 5C is a conceptual diagram of an example focus tunable lens in an artificial reality headset for a user with hyperopia or presbyopia according to some implementations of the present technology.

FIG. 6 is a flow diagram illustrating a process used in some implementations for correcting myopia, hyperopia, and presbyopia using focus tunable lenses on an artificial reality headset.

FIG. 7A is a wire diagram illustrating a virtual reality headset which can be used in some implementations of the present technology.

FIG. 7B is a wire diagram illustrating a mixed reality headset which can be used in some implementations of the present technology.

FIG. 7C is a wire diagram illustrating controllers which, in some implementations, a user can hold in one or both hands to interact with an artificial reality environment.

FIG. 8 is a conceptual diagram of a headset showing internal positioning of sensor components which can be used in some implementations of the present technology.

FIG. 9 is a conceptual diagram of a headset and controllers on a charging dock which can be used in some implementations of the present technology.

FIG. 10 is a flow diagram illustrating a process used in some implementations for calibrating a headset.

FIG. 11 is a flow diagram illustrating a process used in some implementations for calibrating a headset.

FIG. 12 is a block diagram illustrating an overview of devices on which some implementations of the present technology can operate.

FIG. 13 is a block diagram illustrating an overview of an environment in which some implementations of the present technology can operate.

### DESCRIPTION

Some of the technology disclosed herein is directed to a virtual reality (VR) adapter for a mixed reality (MR) head-mounted display (HMD), such as MR glasses. Compared to VR HMDs, MR glasses are likely to have a lower field of view, shorter battery life, difficulty showing more than a few content items at a time, and light saturation issues. Further, MR glasses are limited in what parts of the real-world they can hide from the user. Thus, some implementations provide a VR adapter for the MR glasses that includes one or more tinting elements that can block the pass-through lenses of the MR glasses, such that light from the real-world cannot be seen. In other implementations, the VR adapter for the MR glasses can be VR screens. In some implementations, the VR adapter can additionally or alternatively include one or more attachments that can block the light from the periphery of the MR glasses.

In some implementations, the VR adapter can provide functionality to the MR glasses, and can be added or removed as needed or desired. For example, the VR adapter can include hardware supportive of existing functionality of the MR glasses (e.g., by providing additional storage, memory, processing, battery power, etc.). In some implementations, the VR adapter can include hardware providing additional functionality that is not preexisting in the MR glasses (e.g., by providing cameras directed at the real-world, cameras directed at the eyes of the user, additional light sources, interfaces, and/or any other hardware supportive of a VR experience that is not ordinarily included in MR glasses). For example, the VR adapter can include additional display screens, such as on the attachments facing a user wearing the MR glasses. Thus, some implementations can give the user a more immersive VR experience by displaying virtual objects not only on the lenses of the MR glasses directly ahead of the user's eyes, but also on a periphery of the user's vision. The VR adapter can be operatively and/or communicatively coupled to the MR glasses (e.g., through a port, plug, or any other wired or wireless connection) such that the VR adapter can draw resources from the MR glasses (e.g., power) and/or can provide resources to the MR glasses (e.g., additional hardware).

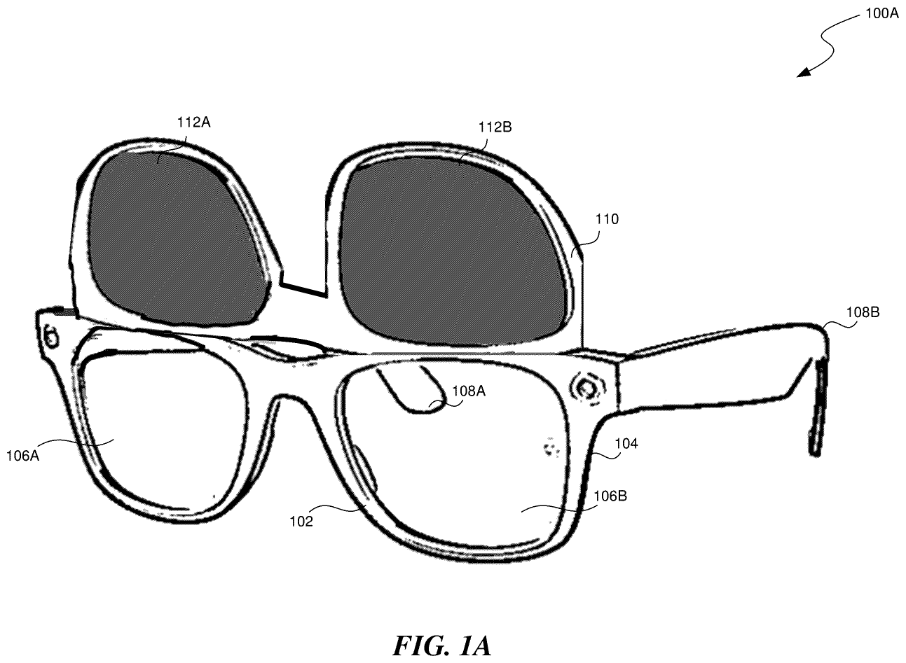

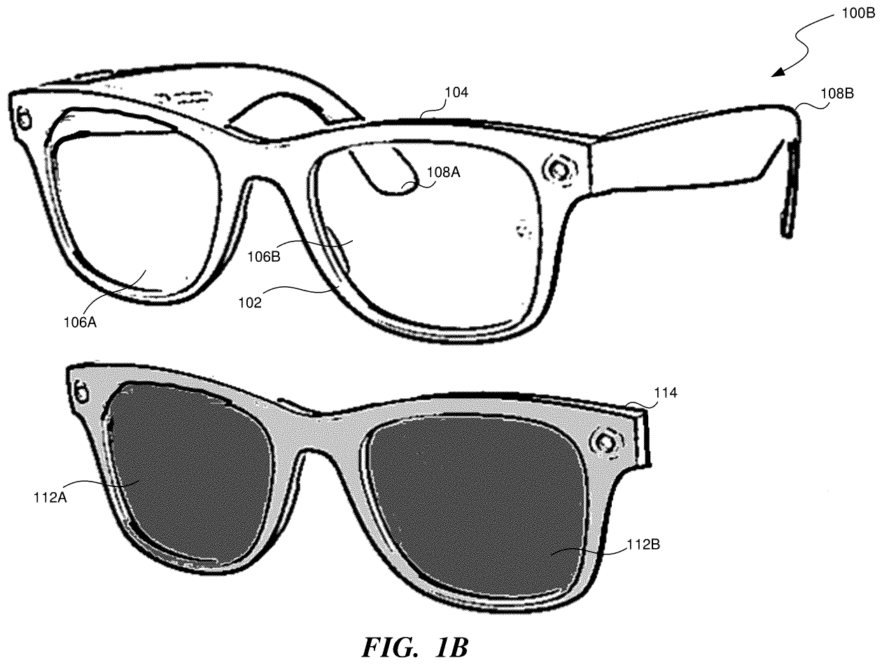

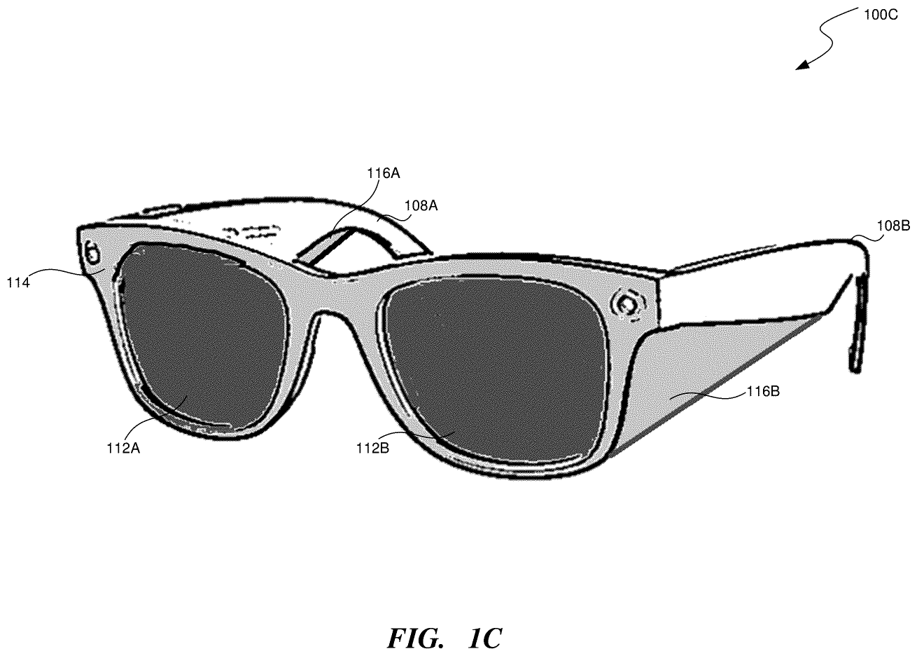

FIG. 1A is a conceptual diagram of an apparatus 100A including MR glasses 102 with a VR adapter including a flip-down cover 110 according to some implementations. MR glasses 102 can include a frame 104, a pair of lenses 106A, 106B attached to frame 104, and a pair of temples 108A, 108B extending from opposite distal ends of frame 104. The pair of lenses 106A, 106B can have a see-through field of view of a real-world environment, i.e., as pass-through lenses. The pair of lenses 106A, 106B can include display elements configured to apply lighting effects to display an XR experience. In some implementations, the XR experience can include virtual objects overlaid onto the real-world environment.

Flip-down cover 110 can include tinting elements 112A, 112B, which can be tinted or blacked-out lenses. Flip-down cover 110 can be attached to frame 104 by one or more hinges (not shown). When moved about the one or more hinges, flip-down cover 110 can be rotated in a downward direction such that tinting elements 112A, 112B can cover lenses 106A, 106B, respectively. Thus, tinting elements 112A, 112B can darken or black out light from the real-world that would ordinarily be seen through lenses 106A, 106B by a user wearing MR glasses 102. When tinting elements 112A, 112B are positioned over lenses 106A, 106B, respectively, lenses 106A, 106B can display a VR experience via display elements in some implementations. In some implementations, lenses 106A, 106B can display an XR experience when tinting elements 112A, 112B are positioned over lenses 106A, 106B, respectively, in cases in which the XR experience is better viewed dimmed or darkened, e.g., when the real-world light is bright.

FIG. 1B is a conceptual diagram of an apparatus 100B including MR glasses 102 and a VR adapter including a clip-on cover 114. Clip-on cover 114 can include tinting elements 112A, 112B, which can be tinted or blacked-out lenses. Clip-on cover 114 can be removably attached to frame 104, such as by being snap-fit onto frame 104 or secured with the use of one or more securing elements, such as a snap or hook (not shown). When clipped onto frame 104, tinting elements 112A, 112B can cover lenses 106A, 106B, respectively. Thus, tinting elements 112A, 112B can darken or black out light from the real-world that would ordinarily be seen through lenses 106A, 106B by a user wearing MR glasses 102. When tinting elements 112A, 112B are positioned over lenses 106A, 106B, respectively, lenses 106A, 106B can display a VR experience via display elements in some implementations. In some implementations, lenses 106A, 106B can display an XR experience when tinting elements 112A, 112B are positioned over lenses 106A, 106B, respectively, in cases in which the XR experience is better viewed dimmed or darkened, e.g., when the real-world light is bright.

Although illustrated with flip-down cover 110 and clip-on cover 114, it is contemplated that the VR adapter can use other tinting elements to apply tint or black out the real-world view through lenses 106A, 106B. For example, the VR adapter can include a tinted or blacked out slider (not shown) that can be pushed over lenses 106A, 106B. In another example, the VR adapter can include a second set of lenses (not shown) having a polymer dispersed liquid crystal (PDLC) film or another electric or chemical tinting that can darken or block out light received through lenses 106A, 106B.

FIG. 1C is a conceptual diagram of an apparatus 100C including MR glasses 102 with a VR adapter including a clip-on cover 114 and attachments 116A, 116B configured to block a peripheral view of a real-world environment from a user wearing the MR glasses 102. Attachments 116A, 116B can extend from frame 104 toward respective distal ends of temples 108A, 108B. Clip-on cover 114 and attachments 116A, 116B can be removably secured to frame 104, such as by being snap-fit onto frame 104 and/or by using of one or more securing elements (not shown), such as a snap or a hook. In some implementations, clip-on cover 114 can be integral with attachments 116A, 116B, such that they can be secured to frame 104 together. In some implementations, clip-on cover 114 can be separate from attachments 116A, 116B and secured to frame 104 separately. Although shown as being used in conjunction with clip-on cover 114, it is contemplated that attachments 116A, 116B can be implemented in conjunction with any of the tinting elements disclosed herein, such as flip-down cover 110.

In some implementations, it is contemplated that attachments 116A, 116B can be implemented with MR glasses 102 without clip-on cover 114 (or any other tinting elements described herein), such as, for example, when a user wearing MR glasses 102 is in a dark environment and does not need further tinting over lenses 106A, 106B. Thus, in some implementations, the attachments 116A, 116B can provide only a partial VR experience. In another example, MR glasses 102 can include a display-enabled VR attachment clipped on to the top region of MR glasses 102 (not shown). In this example, MR experiences can be enabled through lenses 106A, 106B of MR glasses 102, while a VR experience can be seen while looking up at the display-enabled VR attachment (not shown). In such implementations, a user can look at content through attachments 116A, 116B (and/or the display-enabled VR attachment (not shown) clipped onto the top region of MR glasses 102) that may be washed out through MR glasses 102.

In some implementations, attachments 116A, 116B and/or clip-on cover 114 (or any of the other tinting elements described herein) can provide functionality to MR glasses 102. For example, attachments 116A, 116B and/or clip-on cover 114 can include hardware supportive of existing functionality of MR glasses 102, such as by providing additional storage, memory, processing, battery power, etc. In some implementations, attachments 116A, 116B and/or clip-on cover 114 can include hardware providing additional functionality that is not preexisting in MR glasses 102 (e.g., depth cameras and/or other image capture devices directed at the real-world and/or eyes of the user, additional light sources, interfaces, and/or any other hardware or software supportive of a VR experience that is not ordinarily included in MR glasses 102). For example, attachments 116A, 116B can include display elements configured to apply lighting effects to display a VR experience, such as through additional display screens and/or controllable ambient lighting for a user's peripheral vision. Thus, some implementations can expand a user's field of view and provide a more immersive VR experience.

Attachments 116A, 116B and/or clip-on cover 114 can be operatively and/or communicatively coupled to MR glasses 102 to draw resources from MR glasses 102 (e.g., to draw power, to receive commands to render and/or display a VR experience, etc.) and/or to provide resources to MR glasses 102 (e.g., additional battery power, processing capabilities, memory, storage, etc.). In some implementations, attachments 116A, 116B and/or clip-on cover 114 can be coupled to MR glasses 102 through a wired connection, e.g., through a port, plug, or other physical mating interface. In some implementations, attachments 116A, 116B and/or clip-on cover 114 can be coupled to MR glasses 102 through a wireless connection, e.g., through a wireless communication network or interface providing at least near-field communication, through an inductive charger, etc.

It is contemplated that attachments 116A, 116B and/or clip-on cover 114 can be readily added or removed from MR glasses 102 as needed or desired by a user of MR glasses 102. For example, as described further herein, clip-on cover 114 may not be necessary when the user is in a dark environment, and thus can be removed to decrease weight of apparatus 100C without affecting display of a VR experience. In another example, the user can remove attachments 116A, 116B if comfort or wearability of apparatus 100C is more important to the user than a more immersive VR experience. In some implementations, MR glasses 102 can include additional attachments (not shown) separate from attachments 116A, 116B and clip-on cover 114 that can include the additional hardware as described herein.

Further, although described as being a VR adapter used for VR experiences, it is contemplated that apparatus 100A, apparatus 100B, and/or apparatus 100C can be used for more immersive XR experiences. For example, in some implementations, apparatus 100A, apparatus 100B, and/or apparatus 100C can be used for augmented reality (AR) experiences by using a camera (or other image capture device) facing away from a user wearing the MR glasses to feed a video of a real-world environment to lenses 106A, 106B, then overlay virtual objects on the video feed.

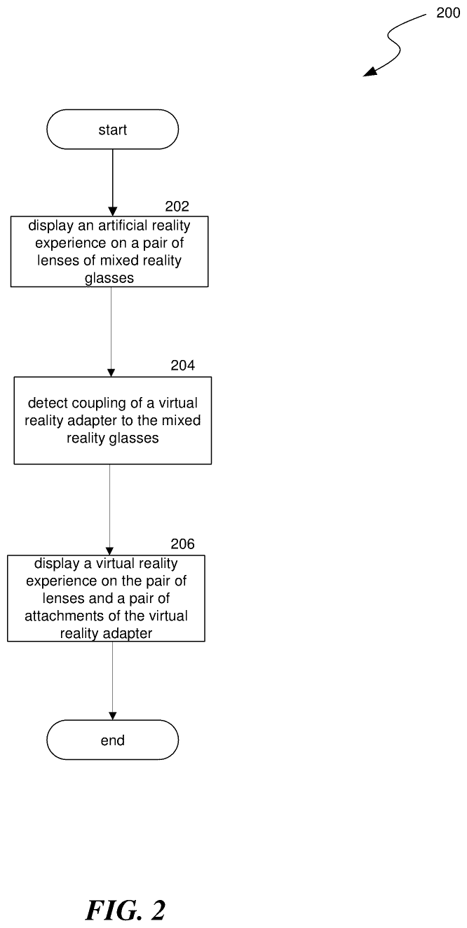

FIG. 2 is a flow diagram illustrating a process 200 used in some implementations for adapting MR glasses for a VR experience. In some implementations, process 200 can be performed as a response to a user request to display a virtual reality (VR) experience on mixed reality (MR) glasses. Process 200 can be performed by any apparatus described herein, the apparatus including the MR glasses and a VR adapter.

At block 202, process 200 can display an XR experience on a pair of lenses of the MR glasses. The MR glasses can include a frame, the pair of lenses which are attached to the frame, and a pair of temples extending from opposite distal ends of the frame. The XR experience can include virtual objects overlaid onto a real-world environment as shown through the pair of lenses, which can have a see-through field of view. Process 200 can display the XR experience using display elements in the pair of lenses that are configured to apply lighting effects to the pair of lenses, e.g., through projection of light to waveguides in the pair of lenses.

At block 204, process 200 can detect coupling of a VR adapter to the MR glasses. For example, the MR glasses can include hardware and/or software capable of detecting receipt of power, instructions, etc. from the VR adapter. The VR adapter can include one or more tinting elements covering the pair of lenses and a pair of attachments blocking a peripheral view of the real-world environment from a user wearing the MR glasses. The one or more tinting elements can include tinted or blacked out lenses integral with a flip-down cover, a clip-on cover, a slider cover, a PDLC film, or another electric or chemical tinting that can darken or block out light received through the pair of lenses, as described further herein. The pair of attachments can be removably secured to the frame or the MR glasses and extend toward respective distal ends of the pair of temples. The pair of attachments can be configured to block a peripheral view of the real-world environment from a user wearing the MR glasses.

In some implementations, the VR adapter (e.g., the one or more tinting elements and/or the pair of attachments) can provide additional hardware to the MR glasses, such as additional storage, drivers, interfaces, memory, battery power, display screens, applications, image capture devices, etc. The VR adapter can be communicatively and/or operatively coupled to the MR glasses to transmit and receive instructions, to provide power or other resources, etc., via one or more wired or wireless connections, such as through external physical coupling (e.g., a plug or port), through a wireless network providing at least near-field communication (e.g., Bluetooth, Bluetooth LE, etc.), through inductive charging, etc. In some implementations, the MR glasses and/or the VR adapter can provide interfaces to interact with each other upon coupling and to execute a set of instructions to load the functionality of the VR adapter, such as by downloading drivers, setting up the VR adapter in the operating system of the MR glasses, offloading processes to additional processors and/or random access memory (RAM) included in the VR adapter, etc.

At block 206, process 200 can display the VR experience on the pair of lenses of the MR glasses and the pair of attachments of the VR adapter. Process 200 can display the VR experience using display elements configured to apply lighting effects to the pair of lenses and the pair of attachments. The lighting effects can include any lighting characteristic of the pair of lenses of the MR glasses and the attachments of the VR adapter, such as tinting of the lens, light output from a display source such as an LED array (e.g., uLED, sLED, oLED, qLED, etc.), laser source (e.g., VCSEL), or other illumination source, adjustable gratings, etc.

An artificial reality (XR) headset can cover the eye region of user and wrap around the sides of the user's head to provide a fully immersive XR experience. However, the XR headset can be difficult to be worn in conjunction with corrective eyeglasses needed to allow a user with myopia, presbyopia, and/or hyperopia to properly view the XR experience. Thus, developers have proposed a number of solutions that allow a user needing corrected vision to properly view an XR experience on an XR headset.

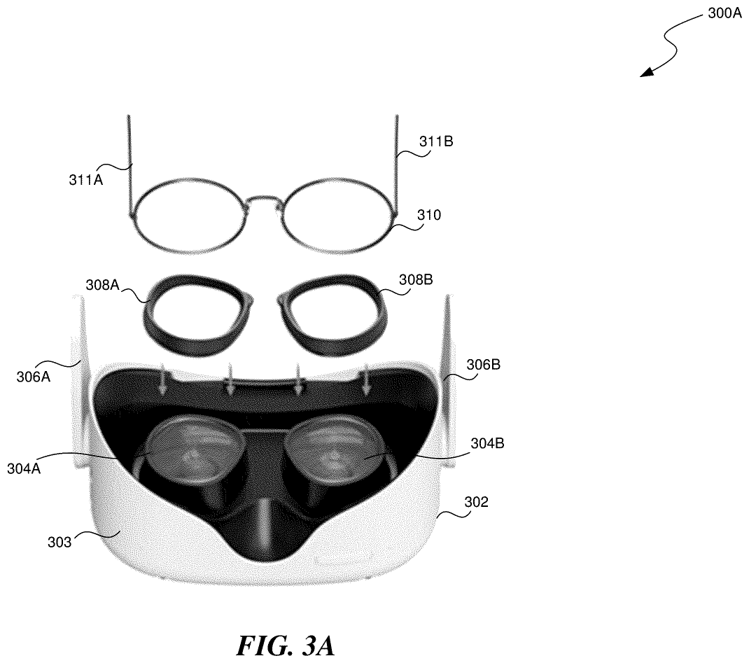

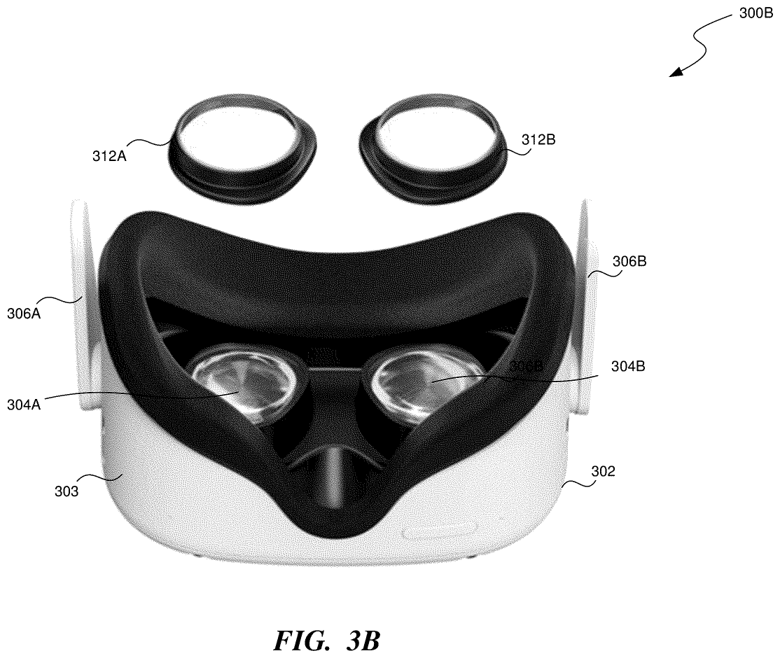

FIG. 3A is a conceptual diagram of an example 300A of an existing XR headset 302 having spacers 308A, 308B to accommodate eyeglasses 310 of a user. XR headset 302 has a rigid body 303, lenses 304A, 304B, and bands 306A, 306B. Rigid body 303 is configured to cover the eye region and periphery of a user's head wearing XR headset 302. Lenses 304A, 304B are configured to display an XR experience. Bands 306A, 306B are configured to wrap around the sides of the user's head to removably secure XR headset 302 to the user's head (e.g., in conjunction with an adjustable band secured to bands 306A, 306B that cover the back of the head (not shown)), such that it is not necessary to hold XR headset 302 in place. Spacers 308A, 308B can be flexibly secured to the frame of eyeglasses 310 and placed between lenses 304A, 304B and eyeglasses 310 to make eyeglasses 310 compatible with XR headset 302. Thus, a user wearing eyeglasses 310 can view an XR experience on lenses 304A, 304B of XR headset 302 with correction for myopia, presbyopia, and/or hyperopia by eyeglasses 310.

However, the proposed solution of example 300A can have a number of drawbacks. For example, spacers 308A, 308B can be hard to fit around thick frame eyeglasses. In addition, bands 306A, 306B can hit and pinch temples 311A, 311B of eyeglasses 310, which can be uncomfortable for long time use. Further, spacers 308A, 308B can leave marks on eyeglasses 310 after spacers 308A, 308B are removed from eyeglasses 310.

FIG. 3B is a conceptual diagram of an example 300B of an existing XR headset 302 having detachable lenses 312A, 312B. Detachable lenses 312A, 312B can be customized to the prescription needed to correct a particular user's myopia, hyperopia, and/or presbyopia, and can be removably secured to lenses 304A, 304B. For example, respective magnetic frames (not shown) can be clipped onto detachable lenses 312A, 312B, with the magnetic frames being magnetically attracted to opposing magnets included on lenses 304A, 304B (not shown). Thus, a user wearing XR headset 302 does not need to wear eyeglasses 310 to view an XR experience on XR headset 302.

However, the proposed solution of example 300B also has drawbacks. For example, detachable lenses 312A, 312B could require a prescription from an optometrist, and would have to be customized for each user having differing myopia, presbyopia, and/or hyperopia prescriptions. Thus, detachable lenses 312A, 312B could be expensive. In addition, the proposed solution of example 300B would require magnetic frames (not shown) between detachable lenses 312A, 312B and lenses 304A, 304B in order to protect lenses 304A, 304B.

To address these disadvantages and others, some implementations of the present technology can correct myopia, hyperopia, and/or presbyopia using focus tunable lenses in an XR headset. The focus tunable lenses can include pairs of clear flexible membranes positioned inside the XR headset between a user's eye region and the lenses of the XR headset. The focus tunable lenses can be filled with an adjustable amount of clear fluid as controlled by a micro electrical motor that can drive the clear fluid into and out of the pairs of clear flexible membranes. Thus, the clear flexible membranes of the focus tunable lenses can be made concave to various degrees to correct various levels of myopia, or convex to various degrees to correct various levels of hyperopia or presbyopia.

As appreciated by one skilled in the art, myopia can be nearsightedness, i.e., when distant objects appear blurred to a user, while close objects appear clearly. Hyperopia can be farsightedness, i.e., when distant objects appear clearly to a user, while close objects appear blurry. Presbyopia can be the loss of an eye's ability to change its focus to see close objects, similar to farsightedness, typically caused by loss of elasticity of the lens of the eye due to aging. Presbyopia can also be referred to as “loss of accommodation” of an eye.

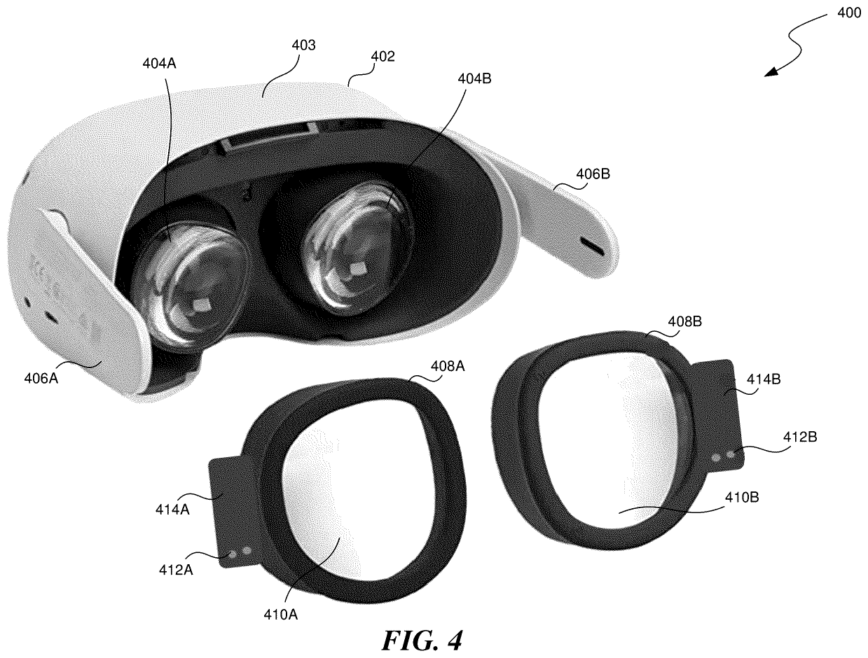

FIG. 4 is a conceptual diagram of an example 400 XR headset 402 having focus tunable lenses 408A, 408B according to some implementations of the present technology. XR headset 402 has a rigid body 403, lenses 404A, 404B, and bands 406A, 406B. Rigid body 403 is configured to cover the eye region and periphery of a user's head wearing XR headset 402. Lenses 404A, 404B are configured to display an XR experience and/or allow a user to view an XR experience. Bands 406A, 406B are configured to wrap around the sides of the user's head to removably secure XR headset 402 to the user's head, such that it is not necessary to hold XR headset 402 in place. In some implementations, bands 406A, 406B can be further secured to an additional band (not shown) configured to wrap around the back of the user's head to further secure XR headset 402.

Focus tunable lenses 408A, 408B can include clear flexible membranes 410A, 410B filled with clear fluid between two layers. In some implementations, the clear fluid can be water. In some implementations, the clear fluid can be a clear fluid other than water that has a constant inflection ratio. Clear flexible membranes 410A, 410B can be made of any suitable clear flexible material, such as transparent plastic, e.g., polymethyl methacrylate (PMMA). Clear flexible membranes 410A, 410B can be fluidly coupled to micro electric motors 414A, 414B that are configured to drive the clear fluid into and out of clear flexible membranes 410A, 410B as needed to correct myopia, presbyopia, and/or hyperopia, as described further herein. Micro electric motors 414A, 414B can drive fluid into and out of clear flexible membranes 410A, 410B from and into a reservoir (not shown). Although shown as having two micro electric motors 414A, 414B, it is contemplated that in some implementations, a single micro electric motor can be used to drive fluid into and out of clear flexible membranes 410A, 410B, Focus tunable lenses 408A, 408B can be coupled to XR headset 402 via pins 412A, 412B, which allow focus tunable lenses 408A, 408B to communicate with XR headset 402, to access an application for adjusting focus tunable lenses 408A, 408B, and/or to receive power from XR headset 402 to drive micro electric motors 414A, 414B. In some implementations, pins 412A, 412B can be pogo pins. While in some implementations, focus tunable lenses 408A, 408B can be removeable from headset 402 (e.g., through magnetic or mechanical connectors) in other implementations, focus tunable lenses 408A, 408B can be fixedly integrated into headset 402.

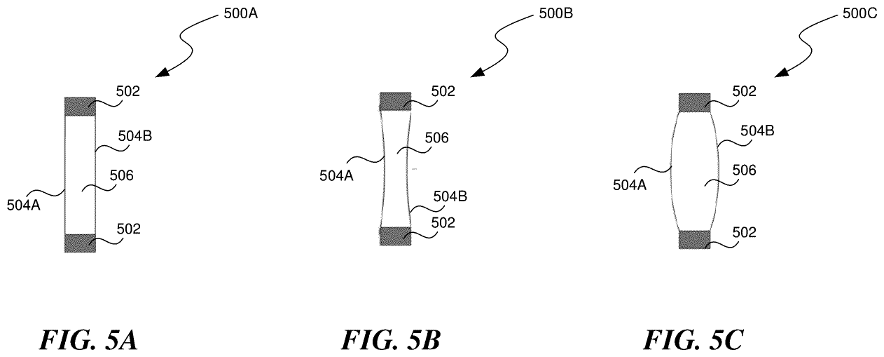

FIG. 5A is a conceptual diagram of an example focus tunable lens 500A in an XR headset for a user with normal vision acuity according to some implementations of the present technology. Focus tunable lens 500A can include lens mounting 502 (e.g., a frame) coupled to clear flexible membranes 504A, 504B. Clear flexible membranes 504A, 504B can be filled with clear fluid 506. In FIG. 5A, focus tunable lens 500A is not deformed, i.e., it does not correct for myopia, hyperopia, or presbyopia, and can be used by a user with normal vision acuity, e.g., 20/20 vision or better. Thus, in some implementations, focus tunable lens 500A does not have to be removed from an XR headset (not shown), even though the XR headset may be used by a user with normal vision acuity that does not require correction.

FIG. 5B is a conceptual diagram of an example focus tunable lens 500B in an XR headset for a user with myopia according to some implementations of the present technology. Clear flexible membranes 504A, 504B can be concave in shape due to a micro electric motor (not shown) pumping clear fluid 506 out of clear flexible membranes 504A, 504B, as described further herein. Because of its concave shape, clear flexible membranes 504A, 504B can correct for myopia by reducing the power of focus tunable lens 500B. In some implementations, a more concave shape of clear flexible membranes 504A, 504B can correct for a more negative power (i.e., more severe nearsightedness), while a less concave shape of clear flexible membranes 504A, 504B can correct for a less negative power (i.e., less severe nearsightedness).

FIG. 5C is a conceptual diagram of an example focus tunable lens 500C in an XR headset for a user with hyperopia or presbyopia according to some implementations of the present technology. Clear flexible membranes 504A, 504B can be convex in shape due to a micro electric motor (not shown) pumping clear fluid 506 into clear flexible membranes 504A, 504B, as described further herein. Because of its convex shape, clear flexible membranes 504A, 504B can correct for hyperopia and/or presbyopia by increasing the power of focus tunable lens 500C. In some implementations, a more convex shape of clear flexible membranes 504A, 504B can correct for a more positive power (i.e., more severe farsightedness or loss of accommodation), while a less convex shape of clear flexible membranes 504A, 504B can correct for a less positive power (i.e., less severe farsightedness or loss of accommodation).

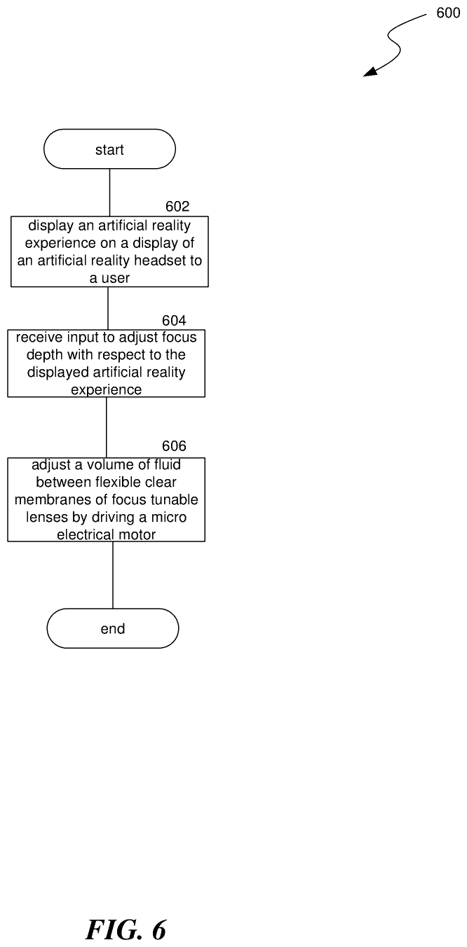

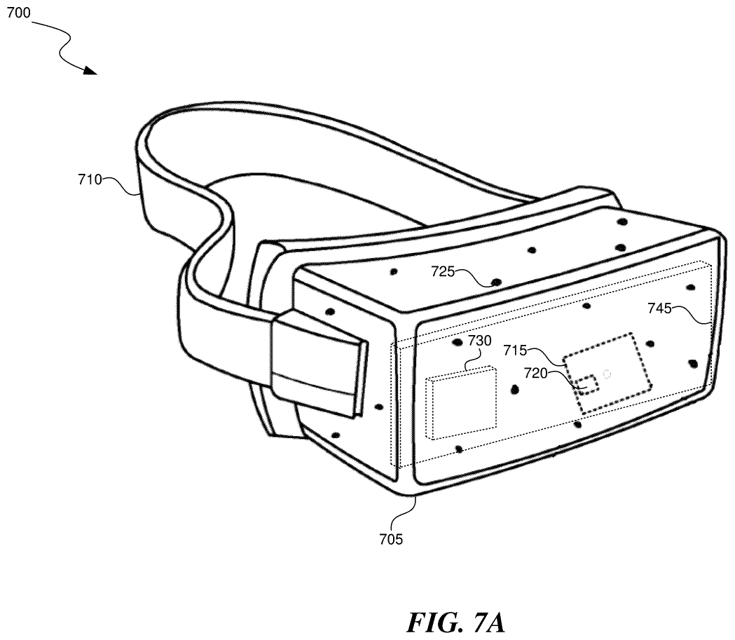

FIG. 6 is a flow diagram illustrating a process 600 used in some implementations for correcting myopia, hyperopia, and presbyopia using focus tunable lenses on an XR headset. In some implementations, process 600 can be performed as a response to a user request to display an XR experience on an XR headset. In some implementations, process 600 can be performed as a response to user input to adjust focus depth with respect to a displayed XR experience on the XR headset. In some implementations, process 600 can be performed automatically upon identification of a particular user of the XR headset, as described further herein. In some implementations, process 600 can be performed by an XR headset described further herein.

At block 602, process 600 can display an XR experience on a display of an XR headset to a user. In some implementations, the display can use lenses of the XR headset. The lenses of the XR headset can be configured to be viewed by a user having normal vision acuity, i.e., 20/20 vision or better. In other words, the lenses of the XR headset do not provide correction for myopia, presbyopia, or hyperopia. Thus, the XR experience being displayed on the XR headset may appear blurry to a user having myopia, presbyopia, and/or hyperopia. In some implementations, process 600 can be performed without block 602, i.e., blocks 604 and 606 as described further herein can be performed before an XR experience is displayed to a user on the XR headset.

At block 604, process 600 can receive input to adjust focus depth with respect to the displayed XR experience. The input can be explicit or implicit. Explicit input can include, for example, instruction by a user, e.g., a verbal instruction, a selection of a virtual input mechanism (e.g., a virtual button being displayed on the XR headset), a selection of a physical input mechanism (e.g., a physical button), etc. Implicit input can include, for example, identification by process 600 of a particular user wearing the XR headset. Process 600 can identify a particular user wearing the XR headset by any suitable method, such as by the user identifying himself from a virtual list of users of the XR headset, by the user speaking her name, by voice recognition of the user, etc.

In response to the received input, at block 606, process 600 can adjust a volume of clear fluid between a pair of clear flexible membranes included in each of the focus tunable lenses. The focus tunable lenses can be positioned between the display displaying XR experience and the user wearing the XR headset. Process 600 can adjust the volume of fluid by driving a micro electrical motor coupled to the focus tunable lenses and a reservoir of the clear fluid. The micro electrical motor can drive the clear fluid into the reservoir and out of the pair clear flexible membranes, and/or out of the reservoir and into the pair clear flexible membranes. For example, when the clear flexible membranes are not deformed (i.e., are configured for a user with normal vision acuity), process 600 can pump the clear fluid out of the pair of clear flexible membranes and into the reservoir in order to make the pair clear flexible membranes concave in shape, correcting for myopia. In another example, when the clear flexible membranes are not deformed, process 300 can pump the clear fluid into the pair of clear flexible membranes and out of the reservoir in order to make the pair of clear flexible membranes convex in shape, correcting for presbyopia and/or hyperopia. However, it is contemplated that in some implementations, process 600 can begin with the clear flexible membranes being deformed, and can pump the clear fluid into and out of the deformed clear flexible membranes as needed to correct for myopia, hyperopia, and/or presbyopia. In some implementations, the focus depth is adjusted by adjusting the volume of fluid during cycling of current changing on the micro electrical motor.

In some implementations, process 600 can adjust the volume of clear fluid between the pair of clear flexible membranes for each of the focus tunable lenses one at a time. For example, in some implementations, the XR headset can display a black view over the left eye (or otherwise cover or block the left eye) while tuning the focus tunable lens for the right eye, and vice versa. In some implementations, process 600 can record calibration data for a particular user in storage for each of that user's eyes in conjunction with an identifier for that user, such that process 600 can automatically adjust the focus tunable lenses for a particular user upon identification of that user and/or upon a particular user donning the XR headset. The adjustment data can include, for example, a volume of fluid needed between the clear flexible membranes for each eye of a particular user, and/or a volume of fluid needed to be added or removed from a nondeformed focus tunable lens for each eye of a particular user.

Head mounted displays (e.g., HMDs) can include a proximity sensor or other location sensors that detect whether a user is wearing the HMD. The reading from the proximity sensor can be used to determine whether the headset is mounted (e.g., on, donning) on the user's head or unmounted (e.g., off) from the user's head and thereby trigger headset OFF and ON events. For example, when the proximity sensor reading is below a low threshold (THDL), the headset is determined to be removed from the user's head, and the headset automatically turns off. When the proximity sensor reading is above a high threshold (THDH), the headset is determined to be on the user's head, and the headset automatically turns on.

To perform headset OFF and ON events, the proximity sensor is calibrated with a baseline setting (PS_CANC). However, sensor drift can occur during handling, transportation, and shipping of the headset. Additionally, the configuration of the headset and positioning of the proximity sensor can create sensor sensitivity to temperature and vibrations. Inaccurate proximity sensor readings can cause the headset to fail automatic OFF and ON events and therefore cause the headset to be in an inaccurate off or on state.

Online calibration can mitigate after factory sensor drift by recalibrating the proximity sensor baseline setting independently of the threshold data used for automatic OFF and ON events. Unpredictable user environments can create challenges for online calibration. For example, online calibration can be skewed if the headset and/or controllers are in a moving state. Accordingly, eliminating or minimizing factors that cause inaccurate calibration is a fundamental component of online calibration. This includes ensuring that the headset and controllers are docked and there is no accidental movement of the headset during online calibration. Accordingly, the aspects described herein perform online calibration when the headset and the controllers are on a charging dock and motion readings from the headset indicate the headset is stationary for a predetermined time period.

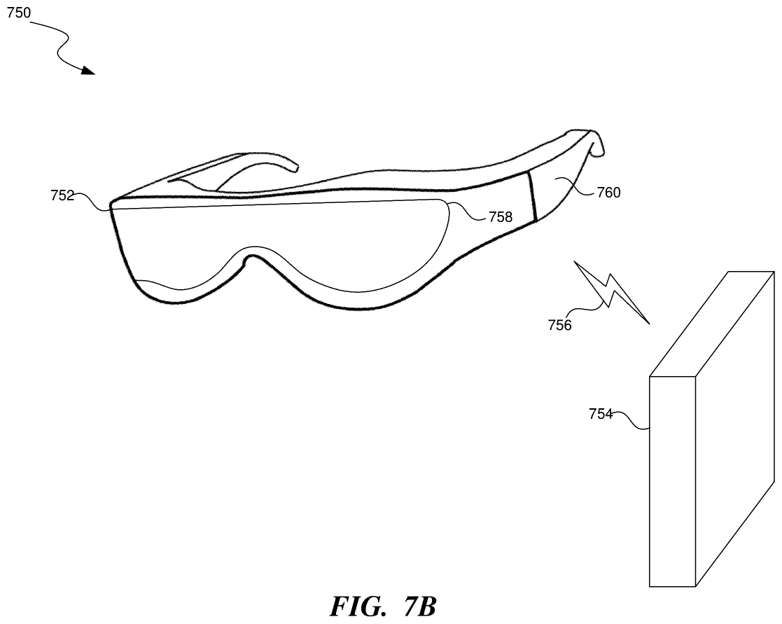

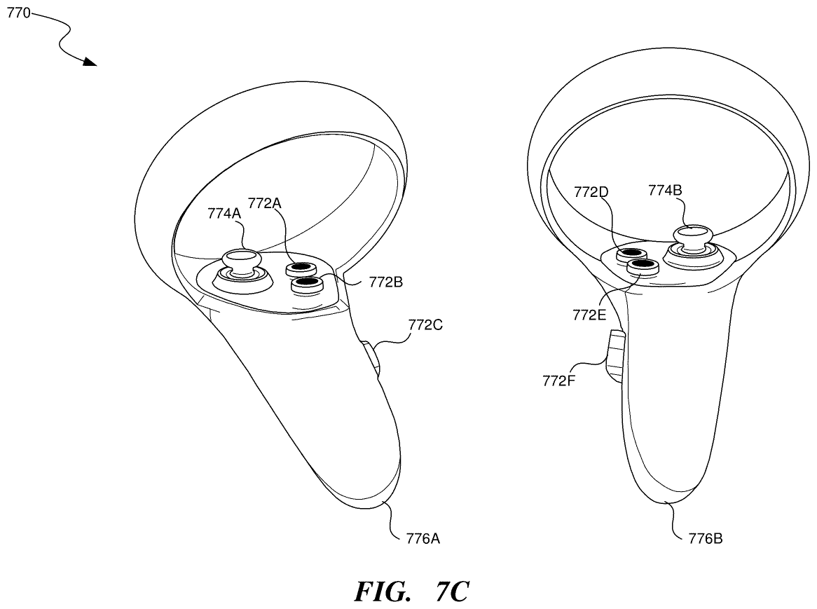

FIG. 7A is a wire diagram of a virtual reality head-mounted display (HMD) 700, in accordance with some embodiments. The HMD 700 includes a front rigid body 705 and a band 710. The front rigid body 705 includes one or more electronic display elements of an electronic display 745, an inertial motion unit (IMU) 715, one or more position sensors 720, locators 725, and one or more compute units 730. The position sensors 720, the IMU 715, and compute units 730 may be internal to the HMD 700 and may not be visible to the user. In various implementations, the IMU 715, position sensors 720, and locators 725 can track movement and location of the HMD 700 in the real world and in an artificial reality environment in three degrees of freedom (3DoF) or six degrees of freedom (6DoF). For example, the locators 725 can emit infrared light beams which create light points on real objects around the HMD 700. As another example, the IMU 715 can include e.g., one or more accelerometers, gyroscopes, magnetometers, other non-camera-based position, force, or orientation sensors, or combinations thereof. One or more cameras (not shown) integrated with the HMD 700 can detect the light points. Compute units 730 in the HMD 700 can use the detected light points to extrapolate position and movement of the HMD 700 as well as to identify the shape and position of the real objects surrounding the HMD 700.

The electronic display 745 can be integrated with the front rigid body 705 and can provide image light to a user as dictated by the compute units 730. In various embodiments, the electronic display 745 can be a single electronic display or multiple electronic displays (e.g., a display for each user eye). Examples of the electronic display 745 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 700 can be coupled to a core processing component such as a personal computer (PC) (not shown) and/or one or more external sensors (not shown). The external sensors can monitor the HMD 700 (e.g., via light emitted from the HMD 700) which the PC can use, in combination with output from the IMU 715 and position sensors 720, to determine the location and movement of the HMD 700.

FIG. 7B is a wire diagram of a mixed reality HMD system 750 which includes a mixed reality HMD 752 and a core processing component 754. The mixed reality HMD 752 and the core processing component 754 can communicate via a wireless connection (e.g., a 60 GHz link) as indicated by link 756. In other implementations, the mixed reality system 750 includes a headset only, without an external compute device or includes other wired or wireless connections between the mixed reality HMD 752 and the core processing component 754. The mixed reality HMD 752 includes a pass-through display 758 and a frame 760. The frame 760 can house various electronic components (not shown) such as light projectors (e.g., LASERs, LEDs, etc.), cameras, eye-tracking sensors, MEMS components, networking components, etc.

The projectors can be coupled to the pass-through display 758, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 754 via link 756 to HMD 752. Controllers in the HMD 752 can convert the image data into light pulses from the projectors, which can be transmitted via the optical elements as output light to the user's eye. The output light can mix with light that passes through the display 758, allowing the output light to present virtual objects that appear as if they exist in the real world.

Similarly to the HMD 700, the HMD system 750 can also include motion and position tracking units, cameras, light sources, etc., which allow the HMD system 750 to, e.g., track itself in 3DoF or 6DoF, track portions of the user (e.g., hands, feet, head, or other body parts), map virtual objects to appear as stationary as the HMD 752 moves, and have virtual objects react to gestures and other real-world objects.

FIG. 7C illustrates controllers 770 (including controller 776A and 776B), which, in some implementations, a user can hold in one or both hands to interact with an artificial reality environment presented by the HMD 700 and/or HMD 750. The controllers 770 can be in communication with the HMDs, either directly or via an external device (e.g., core processing component 754). The controllers can have their own IMU units, position sensors, and/or can emit further light points. The HMD 700 or 750, external sensors, or sensors in the controllers can track these controller light points to determine the controller positions and/or orientations (e.g., to track the controllers in 3DoF or 6DoF). The compute units 730 in the HMD 700 or the core processing component 754 can use this tracking, in combination with IMU and position output, to monitor hand positions and motions of the user. The controllers can also include various buttons (e.g., buttons 772A-F) and/or joysticks (e.g., joysticks 774A-B), which a user can actuate to provide input and interact with objects.

In various implementations, the HMD 700 or 750 can also include additional subsystems, such as an eye tracking unit, an audio system, various network components, etc., to monitor indications of user interactions and intentions. For example, in some implementations, instead of or in addition to controllers, one or more cameras included in the HMD 700 or 750, or from external cameras, can monitor the positions and poses of the user's hands to determine gestures and other hand and body motions. As another example, one or more light sources can illuminate either or both of the user's eyes and the HMD 700 or 750 can use eye-facing cameras to capture a reflection of this light to determine eye position (e.g., based on set of reflections around the user's cornea), modeling the user's eye and determining a gaze direction.

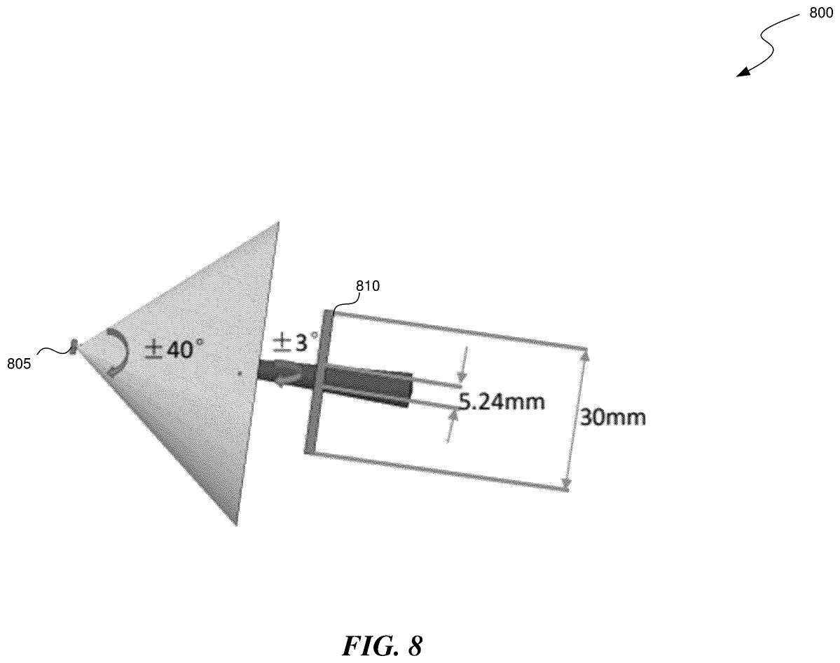

Referring now to FIG. 8, a conceptual diagram of an exemplary headset 800 showing the internal positioning of sensor components is shown. It is understood that the headset 800 can include the same and/or similar components as the HMD 700 and/or the HMD system 750 of FIGS. 7A and 7C. In FIG. 8, the headset 800 includes a proximity sensor 805 and a gray card 810, which together can be referred to as a stack up. As shown in FIG. 8, the proximity sensor 805 and the gray card 810 are tilted, which makes the proximity sensor 805 more sensitive to drops and temperature after leaving the factory.

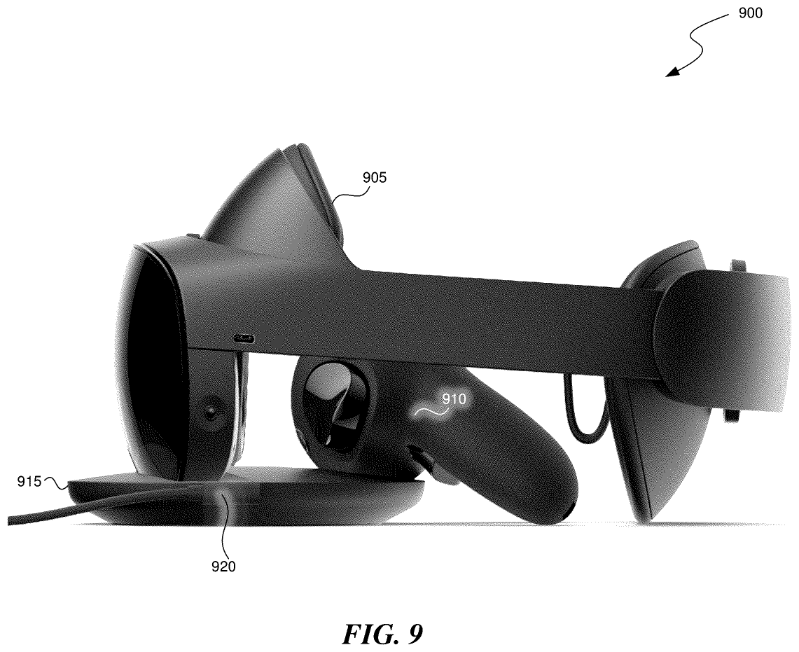

FIG. 9 is a side-view of an XR system 900 in a docked state. The XR system 900 includes a virtual reality headset 905, a controller 910, a charging dock 915 and a charging cord 920. Although the side-view of the XR system 900 in FIG. 9 shows a single controller, it is understood that the XR system 90 can include a second controller like the controller 776A and the controller 776B shown in FIG. 7C. The charging cord 920 can be connected to a power source (not shown). For the online calibration process described herein, the XR system 900 is docked (e.g., a docked state) to the charging dock 915 to minimize interferences during the calibration process.

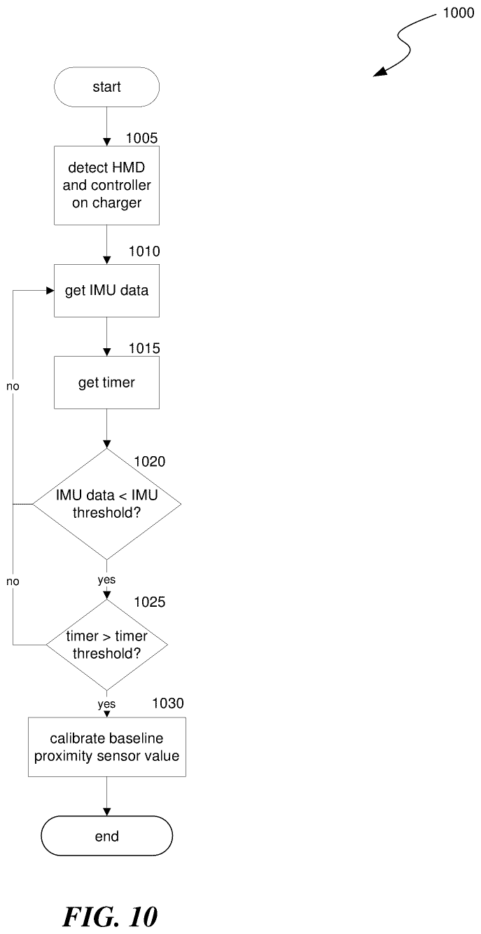

Referring now to FIG. 10, FIG. 10 illustrates a flow diagram of a process 1000 used in some implementations for calibrating a headset. In some implementations, process 1000 can be performed as a response to a user request for calibration or can be initiated as part of the operating system or other control application that is automatically run when the HMD 700 is powered on. In some implementations, process 1000 can be performed ahead of time e.g., upon initial setup of the headset or on a schedule.

At block 1005, process 1000 can detect that a headset, a first controller, and a second controller are connected to a charging dock (e.g., in a docked state). For example, with reference to FIG. 9 the headset 905 and the controller 910 are placed on the charging dock 915. At block 1010, the process 1000 can retrieve a measurement from the IMU 715 indicating motion of the HMD 700. In some implementations, one or both of the controllers 770 can have their own instance of an IMU, similar to IMU 715 and, at block 1010, process 1000 can also receive measurements from these IMU(s).

At block 1015, process 1000 can retrieve a timer. At block 1020, the IMU measurements received at block 1010 are compared to an IMU threshold, where the IMU threshold is a value indicating that the HMD 700, and in some implementations, one or both controllers 770, is motionless (e.g., IMU measurement is near zero). If the determination at block 1020 is YES, process 1000 proceeds to block 1025. Otherwise, if the determination at block 1020 is NO, process 1000 returns to block 1010.

At block 1025, process 1000 can compare the timer retrieved at block 1015 to a predetermined threshold to determine that the HMD 700 and, in some implementations, one or both of the controllers 770, are stationary for a predetermined time threshold. For example, if the IMU 715 (and other IMUs) has no measurement readings (e.g., IMU data<IMU threshold) for more than thirty (30) seconds, the HMD 700 (and controllers 770) is determined to be in a stationary state. If the determination at block 1025 is NO, process 1000 returns to block 1010. Otherwise, if the determination at block 1025 is YES, process 1000 proceeds to block 1030.

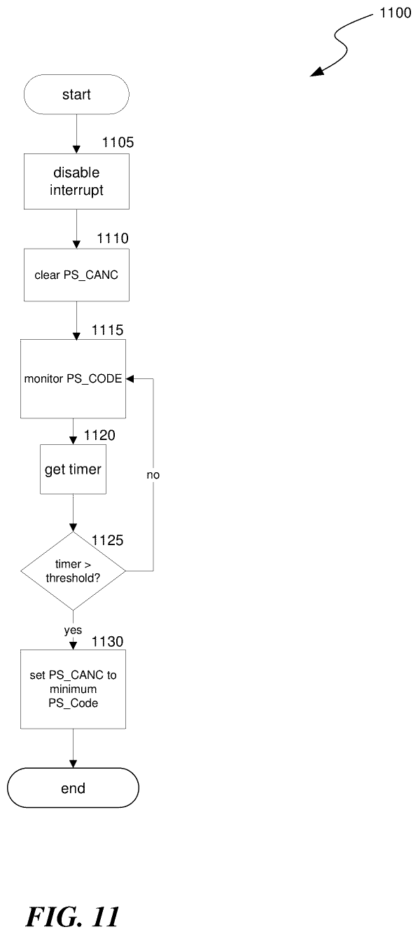

At block 1030, process 1000 can calibrate a baseline proximity sensor value. Accordingly, if the headset and controllers are on the charging dock and the headset is in a stationary state as determined above, calibration of the baseline proximity sensor value is executed. Block 1030 is described in more detail with respect to FIG. 11.

FIG. 11 is a flow diagram illustrating a process 1100 used in some implementations for calibrating the baseline proximity sensor value. In some implementations, process 1100 can be performed as a response to the determinations described above in FIG. 10.

At block 1105, process 1100 can disable the automatic OFF and ON event process (e.g., interrupt process). In some implementations, this includes disabling the low threshold (THDL) and high threshold (THDH) values.

At block 1110, process 1100 can clear the baseline setting (PS_CANC) of the proximity sensor. At block 1115, the process 1100 can monitor a proximity sensor measurement (PS_CODE) [[Inventor Tang: Please confirm the definition of PS_CODE]]. More specifically, at block 1120, process 1100 can retrieve a timer for monitoring the proximity sensor measurement. At block 1125, process 1100 can compare the timer to a predetermined time threshold. For example, the PS_CODE can be monitored for a predetermined time threshold of ten (10) seconds. If the predetermined time threshold condition is satisfied at block 1125 (YES), process 1100 proceeds to block 1130. Otherwise, if the predetermined time threshold condition is not met (NO), process 1100 returns to block 1115.

At block 1130, process 1100 can recalibrate the baseline setting (PS_CANC) of the proximity sensor based on the monitored PS_CODE. For example, the PC_CANC value is set to the minimum PS_CODE value read during the predetermined time threshold.

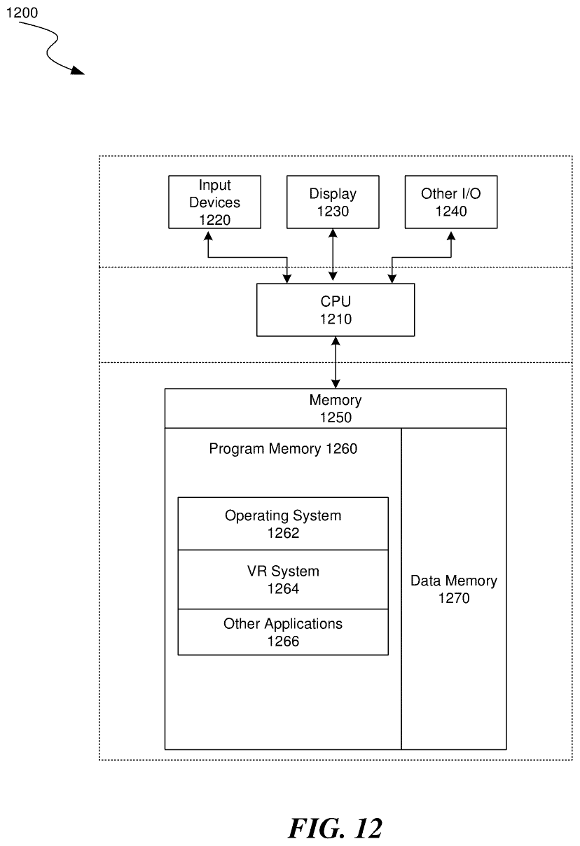

FIG. 12 is a block diagram illustrating an overview of devices on which some implementations of the disclosed technology can operate. The devices can comprise hardware components of a device 1200 as shown and described herein. Device 1200 can include one or more input devices 1220 that provide input to the Processor(s) 1210 (e.g., CPU(s), GPU(s), HPU(s), etc.), notifying it of actions. The actions can be mediated by a hardware controller that interprets the signals received from the input device and communicates the information to the processors 1210 using a communication protocol. Input devices 1220 include, for example, a mouse, a keyboard, a touchscreen, an infrared sensor, a touchpad, a wearable input device, a camera- or image-based input device, a microphone, or other user input devices.

Processors 1210 can be a single processing unit or multiple processing units in a device or distributed across multiple devices. Processors 1210 can be coupled to other hardware devices, for example, with the use of a bus, such as a PCI bus or SCSI bus. The processors 1210 can communicate with a hardware controller for devices, such as for a display 1230. Display 1230 can be used to display text and graphics. In some implementations, display 1230 provides graphical and textual visual feedback to a user. In some implementations, display 1230 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1240 can also be coupled to the processor, such as a network card, video card, audio card, USB, firewire or other external device, camera, printer, speakers, CD-ROM drive, DVD drive, disk drive, or Blu-Ray device.

In some implementations, the device 1200 also includes a communication device capable of communicating wirelessly or wire-based with a network node. The communication device can communicate with another device or a server through a network using, for example, TCP/IP protocols. Device 1200 can utilize the communication device to distribute operations across multiple network devices.

The processors 1210 can have access to a memory 1250 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1250 can include program memory 1260 that stores programs and software, such as an operating system 1262, VR system 1264, and other application programs 1266. Memory 1250 can also include data memory 1270, which can be provided to the program memory 1260 or any element of the device 1200.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

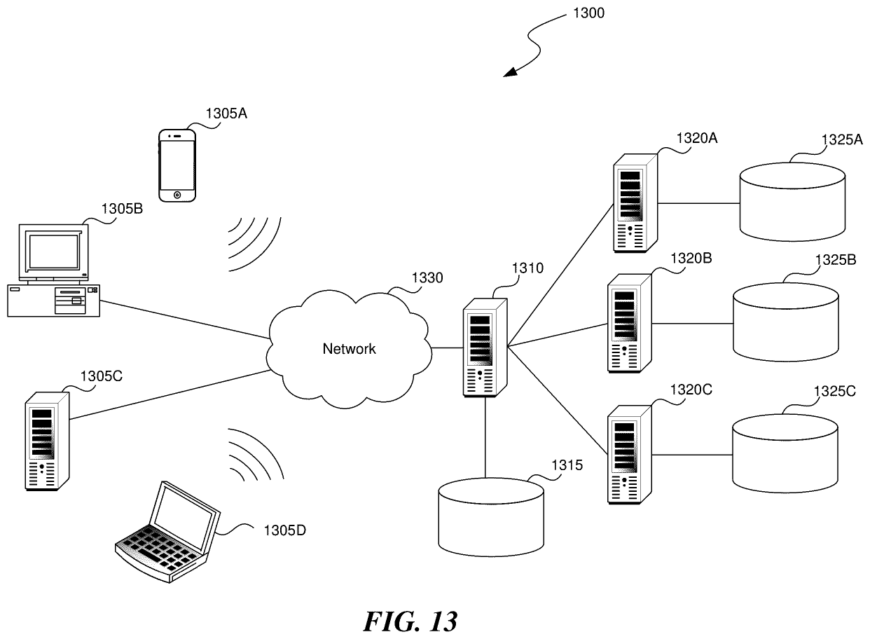

FIG. 13 is a block diagram illustrating an overview of an environment 1300 in which some implementations of the disclosed technology can operate. Environment 1300 can include one or more client computing devices 1305A-D, examples of which can include device 1200. Client computing devices 1305 can operate in a networked environment using logical connections through network 1330 to one or more remote computers, such as a server computing device.

In some implementations, server 1310 can be an edge server which receives client requests and coordinates fulfillment of those requests through other servers, such as servers 1320A-C. Server computing devices 1310 and 1320 can comprise computing systems, such as device 1200. Though each server computing device 1310 and 1320 is displayed logically as a single server, server computing devices can each be a distributed computing environment encompassing multiple computing devices located at the same or at geographically disparate physical locations. In some implementations, each server 1320 corresponds to a group of servers.

Client computing devices 1305 and server computing devices 1310 and 1320 can each act as a server or client to other server/client devices. Server 1310 can connect to a database 1315. Servers 1320A-C can each connect to a corresponding database 1325A-C. As discussed above, each server 1320 can correspond to a group of servers, and each of these servers can share a database or can have their own database. Databases 1315 and 1325 can warehouse (e.g., store) information. Though databases 1315 and 1325 are displayed logically as single units, databases 1315 and 1325 can each be a distributed computing environment encompassing multiple computing devices, can be located within their corresponding server, or can be located at the same or at geographically disparate physical locations.

Network 1330 can be a local area network (LAN) or a wide area network (WAN), but can also be other wired or wireless networks. Network 1330 may be the Internet or some other public or private network. Client computing devices 1305 can be connected to network 1330 through a network interface, such as by wired or wireless communication. While the connections between server 1310 and servers 1320 are shown as separate connections, these connections can be any kind of local, wide area, wired, or wireless network, including network 1330 or a separate public or private network.

In some implementations, servers 1310 and 1320 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021 and now issued as U.S. Pat. No. 11,402,964 on Aug. 2, 2022, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. An apparatus for adapting mixed reality glasses for a virtual reality experience, the apparatus comprising:
the mixed reality glasses, the mixed reality glasses including:
a frame;
a pair of lenses attached to the frame, the pair of lenses having a see-through field of view of a real-world environment; and
a pair of temples extending from opposite distal ends of the frame; and
a virtual reality adapter, the virtual reality adapter including:
one or more tinting or blackout elements configured to cover the pair of lenses; and
a pair of attachments that, when the virtual reality adapted is secured to the frame, extend toward respective distal ends of the pair of temples, the pair of attachments being configured to block a peripheral view of the real-world environment from a user wearing the mixed reality glasses,
wherein the pair of lenses and the pair of attachments include display elements configured to apply lighting effects to display the virtual reality experience.

2. An apparatus for correcting myopia, hyperopia, and presbyopia of a user of an artificial reality headset, the apparatus comprising:
the artificial reality headset, the artificial reality headset including a display configured to display an artificial reality experience to the user;
a pair of focus tunable lenses, each focus tunable lens of the pair of focus tunable lenses including a pair of clear flexible membranes positioned proximate to the display inside the artificial reality headset, each pair of the clear flexible membranes being filled with clear fluid therebetween; and
a micro electrical motor coupled to the pair of focus tunable lenses and configured to drive the clear fluid into and out of each pair of the clear flexible membranes.

3. A method for calibrating a headset, the method comprising:
determining the headset, a first controller, and a second controller are connected to a charging dock; and
upon determining, based on a reading from an inertial measurement unit that the headset is stationary for a predetermined time threshold, calibrating a baseline proximity sensor value of the headset.
